(19) United States
(12) Patent Application Publication
(10) Pub. No.: US 2026/0100603 A1
(43) Pub. Date: Apr. 9, 2026

(54) LOAD CONTROL SWITCH WITH DISTRIBUTED INTELLIGENCE

(71) Applicant: Itron, Inc., Liberty Lake, WA (US)

(72) Inventors: Jamie Coffel, Shakopee, MN (US); Howard Ng, Towaco, NJ (US)

(21) Appl. No.: 19/248,358

(22) Filed: Jun. 24, 2025

Related U.S. Application Data
(60) Provisional application No. 63/703,795, filed on Oct. 4, 2024.

(51) Int. Cl. H02J 13/00; H02J 3/00

(52) U.S. Cl. CPC H02J 13/12; H02J 3/003; H02J 2103/35

(57) ABSTRACT

A smart load control device can include a network interface controller (NIC) including memory storing one or more distributed intelligence (DI) agents that configure the smart load control device to perform operations such as monitoring electricity consumption by a first load at a first service site; receiving operational status data representing an operational status of a second load at a second service site; and/or controlling provision of control circuit wiring or mains power to the first load based at least in part on monitoring the first load and the operational status of the second load, to maintain a total electricity consumption of the first service site and the second service site below a threshold electricity consumption.

### CROSS REFERENCE TO RELATED APPLICATION

This application claims priority to U.S. Provisional Application No. 63/703,795, filed Oct. 4, 2024, the entirety of which is incorporated herein by reference.

### BACKGROUND

Utility companies provide electricity, gas, water, oil, and/or other consumables or services (e.g., sewer, etc.) to consumers. Load control switches exist that utilities use to control water heaters, air conditioners, pool pumps, and other appliances to avoid peaks on a system or manage a load as part of a time-of-use (TOU) program. However, conventional load control switches generally include a standard relay which traditionally merely turns loads on or off to shed the loads. Existing load control switches do not have the ability to provide more nuanced or granular control of appliances (e.g., autonomously change a setting on a thermostat without turning the heater or air conditioner off entirely, lower a temperature set point on a water heater, etc.).

More recently, some smart meters have included functionality enabling the meters to communicate with more advanced loads like battery inverters, smart inverters, battery storage systems via Wi-Fi using IEEE 2030.5, and home area network devices (e.g., thermostats).

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a diagram illustrating an example networked environment or architecture in which at least one network communication device includes a smart load control device configured with distributed intelligence (DI) agents and logic for controlling provisions of control circuit wiring or mains power to one or more loads to maintain a total electricity consumption of one or more service sites below a threshold electricity consumption.

FIG. 2 is a diagram showing details of an example smart load control device configured to control provisions of control circuit wiring or mains power to one or more loads to maintain a total electricity consumption of one or more service sites below a threshold electricity consumption.

FIG. 3 is a flow diagram showing an example method for performing techniques of controlling provisions of control circuit wiring or mains power to one or more loads to maintain a total electricity consumption of one or more service sites below a threshold electricity consumption.

FIG. 4 is a flow diagram showing an example method for performing techniques of determining appliance performance benchmarking.

### DETAILED DESCRIPTION

This disclosure describes a smart load control device configured with distributed intelligence (DI) agents and logic so that the DI agents and logic enable the load control device to perform DI functions that smart meters could previously perform (e.g., communicating with smart devices on the network via WiFi, power line communication (PLC), or other wired networking protocol or wireless networking protocol) as well as DI functions that load control switches previously performed (i.e., controlling dumb appliances or other loads that don't have and are void of network communication functionality). The DI functionality implemented by the smart load control device may additionally or alternatively include the ability to orchestrate loads within a services site and monitor energy consumption by individual loads in real time. The DI functionality implemented by the smart load control device may additionally or alternatively include the ability to provide appliance performance benchmarking. For example, the DI functionality implemented by the smart load control device may flag loads (e.g., heating, ventilation, and air conditioning (HVAC) loads, water heater loads, etc.) that exhibit declining performance (e.g., runtimes normalized against weather) and may target for energy efficiency program marketing (e.g., HVAC tune ups, high efficiency rebates, etc.) The DI functionality implemented by the smart load control device may additionally or alternatively include the ability to provide advanced time of use (TOU) rates possibly with smart phone app support. For example, the DI functionality implemented by the smart load control device may allow users to opt out of time of use (TOU) control periods for any reason and/or may track the users opt outs of TOU control periods versus a program limit, and/or display added energy cost in order for the users to opt out of the TOU control periods. The DI functionality implemented by the smart load control device may additionally or alternatively include the ability to provide customer engagement with smart phone app support. For example, the DI functionality implemented by the smart load control device may track air conditioning (A/C) runtime and/or water heater runtime and/or energy costs for behavioral programs. In another example, with regard to local energy orchestration, the DI functionality implemented by the smart load control device may coordinate between advanced Distributed Energy Resources (DERs) (e.g., IEEE 2030.5) and traditional HVAC and/or water heater loads (e.g., manage premise level energy buy, store, and/or sell options). The DI functionality implemented by the smart load control device may additionally or alternatively include the ability to provide for autonomous frequency and voltage response (e.g., over voltage and/or under voltage). For example, the DI functionality implemented by the smart load control device may provide grid protection and aid in voltage event recovery. The DI functionality implemented by the smart load control device may additionally or alternatively include the ability to provide for transformer protection. For example, the DI functionality implemented by the smart load control device may provide multi-premise management of coincident peak loads on distribution transformers. The DI functionality implemented by the smart load control device may additionally or alternatively include the ability to provide for remote relay. For example, the DI functionality implemented by the smart load control device may externally control a relay for loads not near an install point. The DI functionality implemented by the smart load control device may additionally or alternatively include the ability to provide for cold water heater protection. For example, the DI functionality implemented by the smart load control device may release a water heater from control when risk of cold water is present, which may be based on historical usage patterns.

By bringing this functionality together in a single device (the smart load control device), utilities have more visibility and are better able to manage consumption of electricity at service sites. This minimizes peaks, reduces loads on transformers or other grid components to prevent overload, and/or balance loads with distributed energy generation and/or storage sources (e.g., solar, wind, geothermal, battery backup, electric vehicles, etc.) in a way that was not previously achievable without such a smart load control device.

In some examples, some or all of the DI functionality may be implemented in a network interface controller (NIC). Such DI enabled NIC may be installed in a load control device to configure the load control device with the functionality of the DI agents. In some examples, the DI enabled NIC can be installed in other types of devices (e.g., relays, transformers, meters, etc.) to provide the respective devices with functionality of the DI agents. For example, the DI enabled NIC may take the form factor as a standardized communication port and module designed to facilitate two-way communication between appliances and a utility (e.g., CTA-2045 module) and/or a wireless only gateway.

In some examples, the smart load control devices may be implemented in the context of an advanced metering infrastructure (AMI) of a utility communication network. However, the smart load control devices described herein are not limited to use in a utility industry AMI. For example, the smart load control devices may be implemented in the context of Distribution Automation, Home Energy Management or any other type of wireless or wired networks. Unless specifically described to the contrary, the techniques described herein are applicable to any communications network, control network, and/or another type of network or system. In one example, the techniques may be implemented in the context of the Internet of Things (IoT).

Thus, some of the advantages in implementing the smart load control devices compared to other implementations may be an ability to monitor the load that it is directly controlling, the other smart appliances that are connected inside the home, and/or the current operational status of other loads in other homes (by using PLC, mesh comm, etc.). This allows for the smart load control device to time share the control of the loads in a way to limit the amount of power drawn on the local portion of an electrical grid (e.g., a portion served by a same transformer, or a portion served by a same substation) at any one time to ensure it is kept within a certain limit for managing overload conditions. By time sharing and/or coordinating the control with other homes so that the control strategy is not aggressive, customer comfort is improved without materially or negatively impacting any particular customer or service site. Another advantage in implementing the smart load control devices compared to other implementations is that by implementing the business logic in the DI agent the functionality of the DI agent can be updated more easily (e.g., the DI agent may be updateable independent of the operating system) than if the DI functionality were implemented in firmware of the load control device. New functions can be added without regression testing the entire load control device. For example, new and/or updated DI agents can be installed on the smart load control device in a manner similar to downloading an app on a smartphone. Installing a new and/or updated DI agent does not require update of the underlying operating system. For example, one or more DI agents stored in memory of the smart load control devices may be updatable independently of the operating system of the smart load control devices. Moreover, another advantage in implementing the smart load control devices compared to other implementations may be by implementing the DI agent, the underlying load control device hardware can be very simple making the hardware more cost effective.

### Example Environment

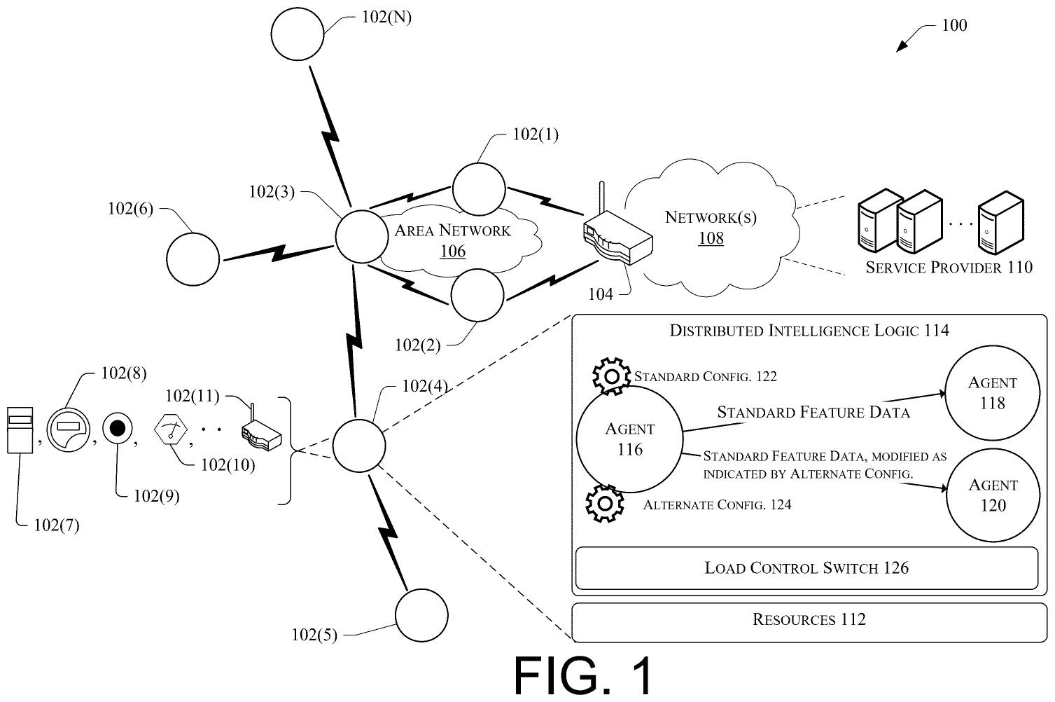

FIG. 1 is a diagram illustrating an example networked environment or architecture 100. The architecture 100 includes multiple network communication devices 102(1)-102(N) (collectively referred to as “network communication devices 102”) and a network communication device 104, where N is any integer greater than or equal to 1. The network communication devices 102 and the network communication device 104 may be in communication with one another via an area network (AN) 106. The AN 106 may be a built around one or more access points covering a relatively small geographic area (e.g., neighborhood). The network communication devices 102 in this example may be, or may include, a smart load control device 102(7), which is configured with DI agents and logic that may reside on a network interface controller (NIC) of the smart load control device 102(7) to enable the smart load control device to perform DI functions such as communicating with smart devices on the network via WiFi, PLC, or other wired or wireless networking protocol, as well as controlling dumb devices that don't have network communication functionality. In another example, the network communication devices 102 may be, or may include, a battery inverter, a smart inverter, a battery storage system, a home appliance, or a smart utility meter. In the example of FIG. 1, the network communication device 104 is implemented as an edge device, which serves as a connection point of the AN 106 to one or more networks 108 (e.g., a backhaul network), such as the Internet. The network communication device 104 may include, but is not limited to, a field area router (FAR), a cellular relay, a cellular router, an edge router, a DODAG (Destination Oriented Directed Acyclic Graph) root, a root device or node of the AN 106, a combination of the foregoing, or the like. In this example, the network communication device 104 relays communications from the AN 106 to a service provider 110 via the one or more networks 108. The network communication device 104 may be considered, for example, a root node of the AN 106. For at least some purposes, the network communication device 104 may be considered a destination network node (at least an intermediate destination) for communications from the network communication devices 102.

As used herein, the term “area network” (AN) refers to a defined group of devices that are in communication with one another via one or more wired or wireless links. Examples of area networks include, for example, local area networks (LANs), neighborhood area networks (NANs), personal area networks (PANs), home area networks (HANs), field area networks (FANs), or the like. While only one AN 106 is shown in FIG. 1, in practice, multiple ANs may exist and may collectively define a larger network, such as an advanced metering infrastructure (AMI) of a utility communication network. At any given time, each individual device may be a member of a particular AN. Over time, however, devices may migrate from one AN to another geographically proximate or overlapping AN based on a variety of factors, such as respective loads on the ANs, battery reserves, interference, or the like.

The term “link” refers to a direct communication path between two devices (without passing through or being relayed by another device). A link may be over a wired or wireless communication path. Each link may represent a plurality of channels over which a device is able to transmit or receive data. Each of the plurality of channels may be defined by a frequency range which is the same or different for each of the plurality of channels. In some instances, the plurality of channels comprises Radio Frequency (RF) channels. The AN 106 may implement a channel hopping sequence, such that a channel may change over time. Although many examples discussed herein implement a plurality of channels as data channels, in some instances the plurality of channels include a control channel that is designated for communicating messages to specify a data channel to be utilized to transfer data. Transmissions on the control channel may be shorter relative to transmissions on the data channels.

The AN 106 may comprise a mesh network, in which the network communication devices relay data throughout the AN 106. Alternatively, or additionally, the AN 106 may comprise a star network, in which a central device acts as a parent to one or more children devices. Further, in some instances the AN 106 may include a portion that is implemented as a mesh network and a portion that is implemented as a star network. Moreover, in other instances the AN 106 may be implemented in whole or part by other types of networks, such as hub-and-spoke networks, mobile networks, cellular networks, etc. In some instances, a device may be able to communicate with multiple different types of networks (e.g., a mesh network and a star network) at the same or different times. For instance, if a device is unable to discover a suitable device in a mesh network mode, the device may attempt to connect to a nearby star network, mobile data collection network, or cellular network. Regardless of the topology of the AN 106, individual network communication devices may communicate by wireless (e.g., radio frequency) and/or wired (e.g., power line communication, Ethernet, serial, etc.) connections.

In some instances, the service provider 110 comprises one or more central office systems that include a security service such as Authentication, Authorization and Accounting (AAA) server, a network registration service such as Dynamic Host Configuration Protocol (DHCP) server, a network management service (NMS), a collection engine (CE), a meter data management system (in the utility context), a customer relationship management system (in the sales context), a diagnostic system (in a manufacturing context), an inventory system (in a warehouse context), a patient record system (in the healthcare context), a billing system, etc. Network communication devices may register or interact with some or all of these one or more central office systems. In one example, the one or more central office systems may implement a meter data management system to collect resource consumption data from the network communication devices of the AN 106, process the resource consumption data, provide data regarding resource consumption to customers, utilities, and others, and/or perform a variety of other functionality. In other instances, the service provider 110 comprises other systems to implement other functionality, such as web services, cloud services, and so on. In yet other instances, the service provider 110 may be implemented as other types of devices, such as in the context of the Internet of Things (IoT) that allows a variety of devices to generate and/or exchange data.

The service provider 110 may be physically located in a single central location, or it may be distributed at multiple different locations. The service provider 110 may be hosted privately by an entity administering all or part of the communications network (e.g., a utility company, a governmental body, distributor, a retailer, manufacturer, etc.), or may be hosted in a cloud environment, or a combination of privately hosted and cloud hosted services.

As noted above, any of the network communication devices 102, the network communication device 104, and/or the service provider 110 may communicate according to various modulation schemes that are available to it and perform processing to determine and indicate a preferred link to use for communication. Available modulation schemes may differ by modulation type and/or by data rate.

The network communication devices 102, such as the network communication device 102(4), may comprise, for example, the smart load control device 102(7), a utility meter 102(8), a control device 102(9) (e.g., a dumb device that does not have and is void of network communication functionality), a sensor 102(10), or a router 102(11). These are examples, and the network communication device 102 may instead or in addition comprise other functionality.

The network communication devices 102, such as the network communication device 102(4), may each include resources 112 as well as distributed intelligence logic 114. At least a portion of the resources 112 and the distributed intelligence logic 114 may be implemented, for example, using a Linux-based processor executing instructions to cause the processor to perform particular operations. The resources 112 may include DI agents such as code that, when executed by a processor of the network communication device 102(4), implements one or more DI agents that comprises the DI application. As another example, the resources 112 may include DI agents of the network communication device 102(4) such as control being made by electronics of the network communication device 102(4), such as controlling a switch (e.g., a load control switch, an electrically operated switch, a relay, etc.) to enable and/or disable electricity consumption by a device, metering electricity usage, sensing electrical line voltage, and/or determining communication metrics corresponding to communication with other network communication devices 102.

The distributed intelligence logic 114 may include one or more agents to accomplish DI application functionality in the network communication device 102(4). An agent may, for example, be developed in C++ and the agents may execute by a processor of the network communication device 102(4) within a Linux Container (LXC). In the FIG. 1 example, the distributed intelligence logic 114 includes three agents—an agent 116, an agent 118 and an agent 120. Each of the agent 116, the agent 118 and the agent 120 includes code that, when executed by a processor of the network communication device 102(4), implements one or more DI agents that comprises the DI application. A DI agent may perform some discrete function and/or produce some output. DI applications are made up of a collection of DI agents, and a DI agent can be a part of more than one DI application.

In the FIG. 1 distributed intelligence logic 114, the agent 116 provides standard feature data to the agent 118 in correspondence with a standard configuration 122 of parameters, and the agent 116 provides the standard feature data, modified as indicated by an alternate configuration 124 of parameters, to the agent 120. For example, the standard configuration 122 of parameters may indicate one or more parameters as input to an algorithm that is being implemented by the agent 116 on a snapshot of the resources 112. The alternate configuration 124 of parameters may indicate how the one or more parameters of the standard configuration 122 of parameters are to be modified as input to the algorithm being implemented by the agent 116. Thus, for example, the standard configuration 122 of parameters may be considered a baseline configuration of parameters that may be provided as input to the algorithm that is being implemented by the agent 116, and the alternate configuration 124 of parameters may be considered as an indication of how the baseline configuration of parameters are to be modified and also provided as input to the algorithm that is being implemented by the agent 116 on the snapshot of the resources 112. The distributed intelligence logic 114 may comprise a load control switch 126 (e.g., one or more relays) configured to control provision of control circuit wiring or mains power to multiple loads at a first service site.

### Example Smart Load Control Device

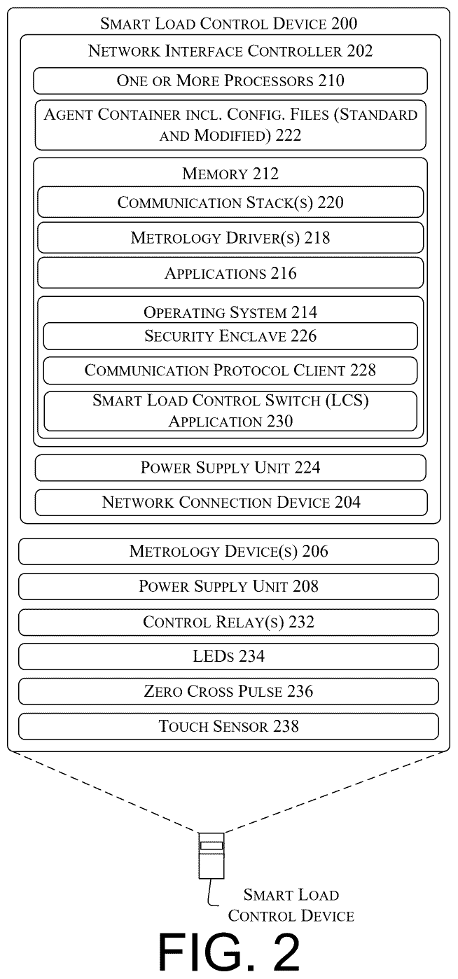

FIG. 2 is a diagram showing details of an example smart load control device 200, such as the smart load control device illustrated in FIG. 1. As shown in FIG. 2, the example smart load control device 200 includes a network interface controller (NIC) 202 that may include a network connection device(s) 204 (e.g., transceiver, radio, modem, etc.), one or more metrology device(s) 206, and a power supply unit 208. The NIC 202 may include one or more processors 210 and memory 212. The one or more processors 210 may comprise microprocessors, central processing units, graphics processing units, or other processors usable to execute program instructions to implement the functionality described herein. Additionally, or alternatively, in some examples, some or all of the functions described may be performed in hardware, such as an application specific integrated circuit (ASIC), a gate array, or other hardware-based logic device.

The network connection device(s) 204 may comprise one or more hardware and/or software implemented radios to provide two-way RF communication with other network communication devices in the AN 106 and/or other devices via the one or more networks 108. The network connection device(s) 204 may additionally or alternatively include a modem to provide power line communication (PLC) with other network communication devices that are connected to an electrical service grid. The network connection device(s) 204 may be configured to communicate with a network communication device at a second service site. For example, the network connection device(s) 204 may be configured to communicate with a battery inverter, a smart inverter, a battery storage system, a home appliance, and/or a smart utility meter at a second service site.

The metrology device(s) 206 may comprise physical hardware and/or sensors to measure consumption data of a resource (e.g., electricity, water, or gas) at a site of the meter. In the case of an electric meter, for example, the metrology device(s) 206 may include one or more Hall effect sensors, shunts, or the like. In the case of water and gas meters, the metrology device(s) 206 may comprise various flow meters, pressure sensors, or the like. The metrology device(s) 206 may report the consumption data to a service provider via the network connection device(s) 204. The consumption data may be formatted and/or packetized in a manner or protocol for transmission.

The power supply unit 208 may provide power to the smart load control device 200. In some instances, the power supply unit 208 comprises a mains power connector that couples to an Alternating Current (AC) or Direct Current (DC) mains power line where the smart load control device 200 is installed. In other instances, the power supply unit 208 comprises a battery, such as a Lithium Thionyl Chloride battery (e.g., a 3-volt battery having an internal impedance rated at 130 Ohms), a Lithium Manganese battery (e.g., a 3-volt battery having an internal impedance rated at 15 Ohms), a Lithium Ion battery, a lead-acid battery, an alkaline battery, and so on.

The memory 212 may include an operating system (OS) 214 and one or more applications 216 that are executable by the one or more processors 210. The memory 212 may also include one or more metrology drivers 218 configured to receive, interpret, and/or otherwise process metrology data collected by the metrology device(s) 206. Additionally, or alternatively, one or more of the one or more applications 216 may be configured to receive and/or act on data collected by the metrology device(s) 206.

The memory 212 may also include one or more communication stack(s) 220. In some examples, the one or more communication stack(s) 220 may be configured to implement an IPv6 over Low-Power Wireless Personal Area Networks (6LowPAN) protocol, an IEEE 802.15.4e (TDMA CSM/CA) protocol, an 802.15.4-2015 protocol, 802.15.4g protocol, and/or another protocol. However, in other examples, other protocols may be used, depending on the networks with which the device is intended to be compatible. The one or more communication stack(s) 220 describe the functionality and rules governing how the smart load control device 200 interacts with each of the specified types of networks. For instance, the one or more communication stack(s) 220 may cause the smart load control device 200 to operate in ways that minimize the battery consumption of the smart load control device 200.

As illustrated, the memory 212 may also include a portion 222 storing at least one agent logic for agents (including programming instructions) that comprise DI applications that run on the OS 214. The portion 222 may also store a standard configuration of parameters according to which an agent may provide standard feature data, such as to another agent. The portion 222 may also store a modified configuration of parameters, according to which the agent may provide the standard feature data, modified as indicated by the modified configuration. For example, the standard configuration of parameters may indicate one or more parameters as input to an algorithm that is being implemented by the agent on a snapshot of resources of the smart load control device 200. The modified configuration of parameters may indicate how the one or more parameters of the standard configuration of parameters are to be modified as input to the algorithm being implemented by the agent. Thus, for example, the standard configuration of parameters may be considered a baseline configuration of parameters that may be provided as input to the algorithm that is being implemented by the agent, and the modified configuration of parameters may be considered as an indication of how the baseline configuration of parameters is to be modified and also provided as input to the algorithm that is being implemented by the agent 116 on the snapshot of the resources.

The memory 212 of the NIC 202 may include software functionality configured as one or more “modules.” The modules are intended to represent example divisions of software for purposes of discussion, and they are not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.).

As illustrated in FIG. 2, the NIC 202 may include a power supply 224. As illustrated, the memory 212 may also include an OS 214, a security enclave 226, a communication protocol client 228 (e.g., a lightweight machine to machine (LwM2M) Client, DLMS COSEM (Device Language Message Specification/Companion Specification for Energy Metering) over cellular, etc.) and a smart load control switch application 230.

The various memories described herein (e.g., memory 212) are examples of computer-readable media. Computer-readable media may take the form of volatile memory, such as random-access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As defined herein, computer-readable media does not include transitory media, such as modulated data signals and carrier waves, and/or signals.

As illustrated, the smart load control device 200 may also include one or more control relays 232 (e.g., metrology device, power supply unit, one or more relays, etc.), one or more LEDs 234, a zero cross pulse 236, and/or a touch sensor 238. The one or more control relays 232 may be configured to control provisions of control circuit wiring or mains power to multiple loads at a first service site. The one or more processors 210 may be communicatively coupled to the one or more control relays 232 and the network connection device(s) 204. The smart load control device 200 may include one or more relays to selectively control provision of control circuit wiring or mains power to one or more loads at the service site.. The smart load control device 200 may comprise a class I/class II circuit separation and/or a high voltage barrier to protect the NIC, processors, memory, and other electronics from the mains power circuit(s).

### Example Methods

In some examples of the techniques discussed herein, the methods of operation may be performed by software defined on memory (e.g., memory 212) and/or application specific integrated circuits (ASIC).

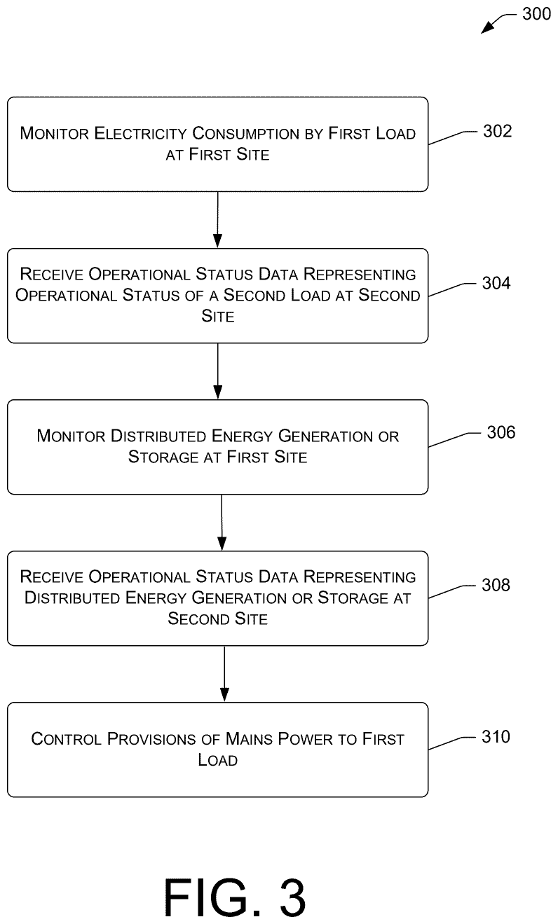

FIG. 3 is a flow diagram showing an example method 300 for performing techniques of controlling provisions of control circuit wiring or mains power to one or more loads to maintain a total electricity consumption of one or more service sites below a threshold electricity consumption.

At operation 302 a smart load control device (e.g., smart load control device 200) may monitor electricity consumption by a first load at a first service site. For example, the smart load control device may monitor electricity consumption by a device (e.g., a water heater, an air conditioner, a pool pump, etc.) void of network communication functionality. While operation 302 describes the smart load control device monitoring electricity consumption by a first load at a first service site, the smart load control device may monitor electricity consumption by multiple devices at the first service site and/or one or more additional service sites.

At operation 304 the smart load control device may receive operational status data representing an operational status of a second load at a second service site. For example, a network connection device (e.g., network connection device 204) of the smart load control device may receive the operational status of the second load at the second service site.

At operation 306 the smart load control device may monitor at least one of distributed energy generation or storage at the first service site.

At operation 308 the smart load control device may receive operational status data representing at least one of distributed energy generation or storage at the second site. For example, the network connection device of the smart load control device may receive operational status data representing at least one of distributed energy generation or storage at the second site.

At operation 310 the smart load control device may control provisions of control circuit wiring or mains power to the first load. In one example, the smart load control device may control provisions of control circuit wiring or mains power to the first load based at least in part on monitoring the first load and the operational status of the second load, to maintain a total electricity consumption of the first service site and the second service site below a threshold electricity consumption. In another example, the smart load control device may control provisions of control circuit wiring or mains power to the first load based at least in part on the at least one of distributed energy generation or storage at the first service site and the at least one of distributed energy generation or storage at the second service site. The distributed generation and/or storage at the first and/or second sites can be any of those examples described throughout the application.

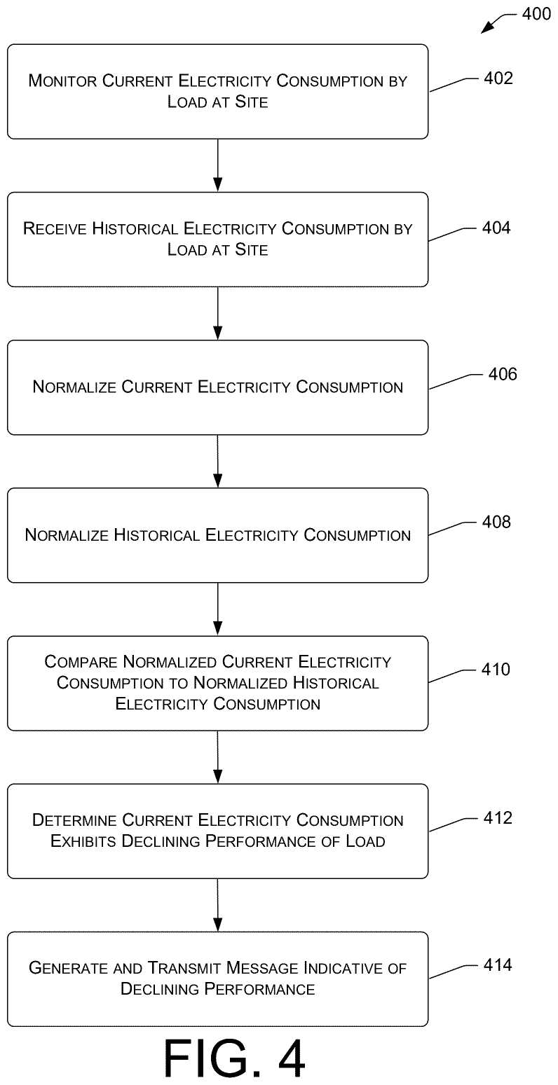

FIG. 4 is a flow diagram showing an example method 400 for performing techniques of determining appliance performance benchmarking.

At operation 402 a smart load control device (e.g., smart load control device 200) may monitor current electricity consumption by a load at a service site. For example, the smart load control device may monitor current electricity consumption by a device (e.g., a water heater, an air conditioner, a pool pump, etc.) at the service site.

At operation 404, the smart load control device may receive historical electricity consumption by the load at the service site.

At operation 406, the smart load control device may normalize the current electricity consumption by the load based at least in part on weather conditions to obtain normalized current electricity consumption.

At operation 408, the smart load control device may normalize the historical electricity consumption by the load based at least in part on weather conditions at the time of the historical electricity consumption to obtain normalized historical electricity consumption.

At operation 410, the smart load control device may compare the normalized current electricity by the load to the normalized historical electricity consumption by the load.

At operation 412, the smart load control device may determine the current electricity consumption by the load exhibits declining performance of the load.

At operation 414, the smart load control device may generate and transmit a message indicative of the declining performance. For example, based at least in part on determining the current electricity consumption by the load exhibits declining performance of the load, the smart load control device may generate and transmit a message indicative of the declining performance.

While detailed examples of certain smart load control devices are described herein, it should be understood that those smart load control devices may include other components and/or be arranged differently. As noted above, in some instances a smart load control device may include one or more processors and memory storing processor executable instructions to implement the functionalities they are described as performing. Certain network communication devices may additionally or alternatively include one or more hardware components (e.g., application specific integrated circuits, field programmable gate arrays, systems on a chip, and the like) to implement some or all of the functionalities they are described as performing. Further, certain smart load control devices may include one or more network interfaces to send or receive data.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A smart load control device comprising:
a load control switch configured to control provision of control circuit wiring or mains power to multiple loads at a first service site;
a network connection device configured to communicate with a network communication device at a second service site;
one or more processors communicatively coupled to the load control switch and the network connection device; and
memory storing one or more distributed intelligence (DI) agents that, when executed by the one or more processors, configure the smart load control device to perform operations comprising:
monitoring electricity consumption by a first load at the first service site;
receiving, by the network connection device, operational status data representing an operational status of a second load at the second service site; and
controlling provision of control circuit wiring or mains power to the first load based at least in part on monitoring the first load and the operational status of the second load, to maintain a total electricity consumption of the first service site and the second service site below a threshold electricity consumption.

2. The smart load control device as recited in claim 1, the operations further comprising:
monitoring at least one of distributed energy generation or storage at the first service site; and
receiving, by the network connection device, operational status data representing at least one of distributed energy generation or storage at the second site;
wherein the controlling provision of control circuit wiring or mains power to the first load is further based at least in part on the at least one of distributed energy generation or storage at the first service site and the at least one of distributed energy generation or storage at the second service site.

3. The smart load control device as recited in claim 1, wherein the network connection device is configured to communicate with the network communication device at the second service site via a wired networking protocol or wireless networking protocol.

4. The smart load control device as recited in claim 3, wherein the network communication device comprises a battery inverter, a smart inverter, a battery storage system, a home appliance, or a smart utility meter.

5. The smart load control device as recited in claim 1, wherein the first load comprises a device void of network communication functionality.

6. The smart load control device as recited in claim 5, wherein the device void of network communication functionality comprises a water heater, an air conditioner, or a pool pump.

7. The smart load control device as recited in claim 1, the memory further storing an operating system, and
wherein the one or more DI agents comprise software applications that run on the operating system.

8. The smart load control device as recited in claim 7, wherein the one or more DI agents are updatable independently of updating of the operating system.

9. The smart load control device as recited in claim 1, wherein the load control switch comprises:
a metrology device;
a power supply unit, or
one or more relays.

10. A method of controlling provision of control circuit wiring or mains power to multiple loads at a first service site comprising:
at a smart load control device associated with the first service site, the smart load control device comprising memory storing one or more distributed intelligence (DI) agents that, when executed by one or more processors, configure the smart load control device to perform operations comprising:
monitoring electricity consumption by a first load at the first service site;
receiving, by a network connection device associated with the smart load control device and configured to communicate with a network communication device at a second service site, operational status data representing an operational status of a second load at the second service site; and
controlling provision of control circuit wiring or mains power to the first load based at least in part on monitoring the first load and the operational status of the second load, to maintain a total electricity consumption of the first service site and the second service site below a threshold electricity consumption.

11. The method as recited in claim 10, the operations further comprising:
monitoring at least one of distributed energy generation or storage at the first service site; and
receiving, by the network connection device, operational status data representing at least one of distributed energy generation or storage at the second site;
wherein the controlling provision of control circuit wiring or mains power to the first load is further based at least in part on the at least one of distributed energy generation or storage at the first service site and the at least one of distributed energy generation or storage at the second service site.

12. The method of claim 10, wherein the network connection device is configured to communicate with the network communication device at the second service site via a wired networking protocol or wireless networking protocol.

13. The method of claim 12, wherein the network communication device comprises a battery inverter, a smart inverter, a battery storage system, a home appliance, or a smart utility meter.

14. The method of claim 10, wherein the first load comprises a device void of network communication functionality.

15. The method of claim 14, wherein the device void of network communication functionality comprises a water heater, an air conditioner, or a pool pump.

16. The method of claim 10, the memory further storing an operating system, and
wherein the one or more DI agents comprise software applications that run on the operating system.

17. The method of claim 16, wherein the one or more DI agents are updatable independently of updating of the operating system.

18. A non-transitory computer-readable medium storing one or more distributed intelligence (DI) agents that, when executed by one or more processors, configure a smart load control device to perform operations comprising:
monitoring electricity consumption by a first load at a first service site;
receiving, by a network connection device associated with the smart load control device and configured to communicate with a network communication device at a second service site, operational status data representing an operational status of a second load at the second service site; and
controlling provision of control circuit wiring or mains power to the first load based at least in part on monitoring the first load and the operational status of the second load, to maintain a total electricity consumption of the first service site and the second service site below a threshold electricity consumption.

19. The non-transitory computer-readable medium as recited in claim 18, the operations further comprising:
monitoring at least one of distributed energy generation or storage at the first service site; and
receiving, by the network connection device, operational status data representing at least one of distributed energy generation or storage at the second site;
wherein the controlling provision of control circuit wiring or mains power to the first load is further based at least in part on the at least one of distributed energy generation or storage at the first service site and the at least one of distributed energy generation or storage at the second service site.

20. The non-transitory computer-readable medium of claim 18, wherein the network connection device is configured to communicate with the network communication device at the second service site via a wired networking protocol or wireless networking protocol.

21. The non-transitory computer-readable medium of claim 18, wherein the network communication device comprises a battery inverter, a smart inverter, a battery storage system, a home appliance, or a smart utility meter.

22. The non-transitory computer-readable medium of claim 18, wherein the first load comprises a device void of network communication functionality.

23. The non-transitory computer-readable medium of claim 22, wherein the device void of network communication functionality comprises a water heater, an air conditioner, or a pool pump.

24. The non-transitory computer-readable medium of claim 18, further storing an operating system, and
wherein the one or more DI agents comprise software applications that run on the operating system.

25. The non-transitory computer-readable medium of claim 24, wherein the one or more DI agents are updatable independently of updating of the operating system.
